(19) United States
(12) Patent Application Publication
(10) Pub. No.: US 2015/0102876 A1
(43) Pub. Date: Apr. 16, 2015

(54) METHOD FOR ACTUATING AN ELECTROMAGNETIC ACTUATOR DEVICE HAVING A COIL

(71) Applicant: CONTINENTAL AUTOMOTIVE GMBH, HANNOVER (DE)

(72) Inventor: JENS MAASE, REGENSBURG (DE)

(21) Appl. No.: 14/514,593

(22) Filed: Oct. 15, 2014

(30) Foreign Application Priority Data
Oct. 15, 2013 (DE) 102013220853.7

(51) Int. Cl. H01F 7/18; H01F 7/16

(52) U.S. Cl. CPC H01F 7/18; H01F 7/1607
USPC 335/255

(57) ABSTRACT

A method for actuating an electromagnetic actuator device having a coil includes providing a plunger to be activated having at least one section movably disposed in the magnetic field, after activation of the plunger, reducing a voltage again by applying an electrical voltage to end the activation, and after an end of the electrical activation of the plunger, applying a magnetization voltage, which is not sufficient for an activation, to the coil for a predefined time period.

### CROSS-REFERENCE TO RELATED APPLICATION

This application claims the priority, under 35 U.S.C. §119, of German Application DE 10 2013 220 853.7, filed Oct. 15, 2013; the prior application is herewith incorporated by reference in its entirety.

### BACKGROUND OF THE INVENTION

### Field of the Invention

The invention relates to a method for actuating an electromagnetic actuator device having a coil, in which at least one section of a plunger which is to be activated is movably disposed in a magnetic field of the coil and in which, after activation of the plunger, a voltage is reduced again by applying an electrical voltage to end the activation.

A large number of electromagnetic actuator devices are used in motor vehicles. In addition to electric motors such as, for example, window lifter motors or windshield wiper motors, coils having a magnetic field which activates plungers are also used. The actuator devices can, for example, be components of electromagnetic injection valves, but also components of actuator devices due to the position of which, for example, sliding cams can be activated.

Such an electromagnetic actuator device for actuating, for example, a sliding cam for a variable valve setting for an internal combustion engine in a motor vehicle is known from International Publication No. WO 03/021612 A1, corresponding to U.S. Pat. No. 6,967,550. In that document, on one hand, an actuator device having a non-magnetic plunger is described in which, in order to activate the plunger, for example in order to intervene in the groove of a sliding cam of a variable valve drive, a coil has to be energized and that energization must also be maintained in the extended state of the plunger. On the other hand, an actuator device is also described which has a permanent magnet which holds the plunger in a retracted state of the actuator device counter to a spring force. In that case, only brief energization is necessary, which generates a force against the retraction force of the permanent magnet in order to set the plunger in motion on the basis of the prestress of a spring, and then to hold the plunger in the extended state on the basis of the spring force. However, in both cases by virtue of an eccentric configuration of the groove of the sliding cam, the plunger is pushed back again into the actuator device and into its position of rest by using a corresponding rotation of the sliding cam.

It is necessary to ensure that the plunger has been pushed back again into its position of rest. When a permanent magnet is used, that can be done by determining the voltage in the coil which is induced by the movement of the plunger, and therefore also of the permanent magnet attached thereto, and of the current flowing through the coil, which current can be detected by using a current-measuring resistor. That will be explained with reference to FIGS. 1 and 2.

FIG. 1 shows a diagrammatic illustration of a coil Sp with a plunger St which can be activated therein in a direction B of movement by energizing the coil Sp. A suitable actuation and evaluation circuit is indicated by reference symbol A. Applying a voltage to the coil of the actuator device, as is illustrated in FIG. 2 as a voltage to a current-measuring resistor, causes a firstly virtually linearly rising current which generates a magnetic field starting from a certain current strength, which is sufficiently large to move the plunger counter to the retraction force of the permanent magnet and to extend it out of the actuator device. After the movement has been set in motion, the current can be held at a constant value. After a predetermined time which is sufficient for the displacement of a sliding cam, the voltage is switched off again, after which the current through the coil decreases again virtually linearly as a result of the dissipation of the magnetic energy stored in the coil. If, at a specific point in time t1, the plunger is pushed back again as a result of a rotation of the sliding cam on the basis, for example, of eccentricity of a groove in which the plunger has engaged, this movement induces, due to the permanent magnet, a sufficiently high voltage in the coil, which voltage can be detected by using the current caused thereby and the determination thereof.

Due to the use of a permanent magnet, the induced voltage is sufficiently high, but a permanent magnet does not entail inexcessive costs. However, a non-magnetic plunger does not induce any voltage during its movement within the coil.

### SUMMARY OF THE INVENTION

It is accordingly an object of the invention to provide a method for actuating an electromagnetic actuator device having a coil, which overcomes the hereinafore-mentioned disadvantages of the heretofore-known methods of this general type and in which a detection of a movement, even of a non-magnetic plunger in a coil, is made possible.

With the foregoing and other objects in view there is provided, in accordance with the invention, a method for actuating an electromagnetic actuator device having a coil with a magnetic field, which comprises providing at least one section of a plunger to be activated so as to be movably disposed in the magnetic field, reducing a voltage again, after activation of the plunger, by applying an electrical voltage to end the activation, and after an end of the electrical activation of the plunger, applying a magnetization voltage, which is not sufficient for an activation, to the coil for a predefined time period.

Advantageous developments are specified in the dependent claims.

After the activation of the plunger of the electromagnetic actuator device, energization of the coil is therefore to take place according to the invention, in which the energization is not sufficient to activate the plunger but magnetizes it to a sufficient degree to induce, by virtue of its movement, a voltage in the coil which can easily be detected. The energization of the coil can be continuous in a first embodiment, but in a second embodiment can also be embodied as an alternating signal, in particular a pulse signal, since in this way a signal which is significant for the movement of the plunger can also be detected.

Other features which are considered as characteristic for the invention are set forth in the appended claims.

Although the invention is illustrated and described herein as embodied in a method for actuating an electromagnetic actuator device having a coil, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a known actuator device;

FIG. 2 is a diagram showing a current profile when a permanent magnet is used in an electromagnetic actuator device;

FIG. 3 is a diagram showing a current profile during the energization of an actuator device without a permanent magnet with continuous subsequent energization according to the invention; and

FIG. 4 is a diagram showing a current profile with subsequent energization with pulse-shaped current according to the invention.

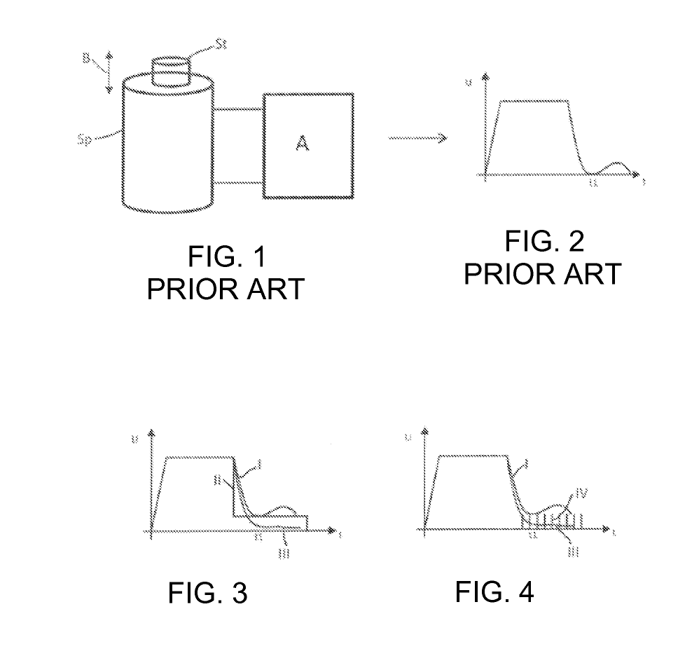

### DETAILED DESCRIPTION OF THE INVENTION

Referring now to the figures of the drawings in detail and first, particularly, to FIGS. 3 and 4 thereof, it is seen that a voltage is firstly applied to a coil Sp of an electromagnetic actuator device, in which the voltage permits a current to flow that is sufficiently large to set a non-permanent-magnetic plunger in motion and to subsequently hold it in an extended position through a virtually constant current, and to then end the activation by switching off the relatively high voltage. This is illustrated by a profile or curve indicated by reference symbol I.

According to the invention, the voltage at the coil is not switched off but instead reduced to a value which is, on one hand, not sufficient to reactivate the plunger due to the current which is caused thereby, but on the other hand, is large enough to magnetize the plunger, with the result that a sufficiently high opposing voltage is induced on the basis of the movement of the plunger which is brought about mechanically from the outside, and the opposing voltage can be detected with simple measures.

FIG. 3 shows in this case a magnetization energization with a virtually constant continuous current, which is denoted by reference symbol III, while in FIG. 4 current pulses with a virtually identical pulse level are illustrated, which is denoted by reference symbol IV. In both cases, a significant increase in the induced current flow can be seen, which increase can be detected with conventional measures, for example by differentiation. In FIGS. 3 and 4, the current profile (reference symbol III) which would occur if no energization according to the invention were to take place, is also indicated. It is clearly apparent that in that case detection would be virtually impossible, or only possible with considerable expenditure.

1. A method for actuating an electromagnetic actuator device having a coil with a magnetic field, the method comprising the following steps:
providing a plunger to be activated, the plunger having at least one section being movably disposed in the magnetic field of the coil;
activating the plunger by applying a voltage to the coil;
after activating the plunger, reducing the voltage by applying an electrical voltage to end the activation; and
after an end of the electrical activation of the plunger, applying a magnetization voltage, not being sufficient for an activation, to the coil for a predefined time period.

2. The method according to claim 1, wherein the magnetization voltage is a direct voltage.

3. The method according to claim 1, wherein the magnetization voltage is an alternating voltage.

4. The method according to claim 3, wherein the alternating voltage is a sequence of voltage pulses.

5. The method according to claim 1, wherein the plunger is a non-permanent-magnetic plunger.
